(19) United States
(12) Patent Application Publication
(10) Pub. No.: US 2007/0200483 A1
(43) Pub. Date: Aug. 30, 2007

(54) Light emission device

(76) Inventors: Sung-Hwan Jin, Yongin-si (KR); Chul-Ho Park, Yongin-si (KR); Zin-Min Park, Yongin-si (KR); Seung-Joon Yoo, Yongin-si (KR); Jung-Ho Kang, Yongin-si (KR); Su-Kyung Lee, Yongin-si (KR); Won-Il Lee, Yongin-si (KR); Kang-Sik Jung, Yongin-si (KR)

Correspondence Address: CHRISTIE, PARKER & HALE, LLP, PO BOX 7068, PASADENA, CA, 91109-7068, US

(21) Appl. No.: 11/707,574

(22) Filed: Feb. 16, 2007

(30) Foreign Application Priority Data
Feb. 20, 2006 (KR) 10-2006-0016413
Oct. 20, 2006 (KR) 10-2006-0102322

(51) Int. Cl. H01J 63/04; H01J 1/62

(52) U.S. Cl. 313/495

(57) ABSTRACT

In an embodiment of the present invention, a light emission device includes a vacuum vessel that includes first and second substrates facing each other and a sealing member for sealing the first and second substrates, an electron emission unit that is located on an inner surface of the first substrate and includes a plurality of electron emission regions and a plurality of driving electrodes for controlling the electron emission of the electron emission regions, a light emission unit that is located on an inner surface of the second substrate, and a heat dissipation layer that defines an uppermost layer of the electron emission unit and has a thermal conductivity of at least 2 W/cmK, a portion of the heat dissipation layer extending out of the vacuum vessel through a region between the sealing member and the first substrate.

### CROSS-REFERENCE TO RELATED APPLICATIONS

This application claims priority to and the benefit of Korean Patent Application Nos. 10-2006-0016413, filed on Feb. 20, 2006, and 10-2006-0102322, filed on Oct. 20, 2006, the entire contents of which are incorporated herein by reference.

### BACKGROUND OF THE INVENTION

1. Field of the Invention

The present invention relates to a light emission device.

2. Description of the Related Art

A device that can emit light to an exterior thereof can be regarded as a light emission device. Such a light emission device has a front substrate on which a phosphor layer and an anode electrode are formed and a rear substrate on which driving electrodes and electron emission regions are formed. The light emission device emits visible light by exciting the phosphor layer by electrons emitted from the electron emission regions.

In the light emission device, a sealing member is provided between the front and rear substrates to seal them together, thereby forming a vacuum vessel. An interior of the vacuum vessel is exhausted to maintain a vacuum pressure of about 10⁻⁶ Torr. Applied to the vacuum vessel is a high compression force caused by a pressure difference between an exterior and the interior of the vacuum vessel. Spacers are installed in the vacuum vessel to counter the compression force applied to the vacuum vessel.

However, when the light emission device is continuously driven for many hours, the driving electrodes may become over-heated. This causes an over-heating of the vacuum vessel as well as a deterioration of a driving stability of the light emission device. In addition, a temperature of the rear substrate on which the driving electrodes are located may be higher than that of the front substrate. As a result, there may be a temperature difference between an end of a spacer contacting the front substrate and an opposite end of the same spacer contacting the rear substrate.

This temperature difference causes a surface electric potential variation along a height direction of the spacer. Accordingly, electron beams traveling around the spacer may be attracted or repelled by the spacer and paths of electron beam paths may become distorted. As a result, a portion of the phosphor layer around the spacer may not be able to emit light uniformly. As such, a luminance uniformity of the light emission display is deteriorated.

### SUMMARY OF THE INVENTION

Aspects of the present invention provide a light emission device wherein a driving stability is improved by suppressing an over-heating of a vacuum vessel and an abnormal light emission around a spacer is suppressed by reducing a temperature difference between front and rear substrates.

In an exemplary embodiment of the present invention, a light emission device includes a vacuum vessel that includes first and second substrates facing each other and a sealing member for sealing the first and second substrates, an electron emission unit that is located on an inner surface of the first substrate and includes a plurality of electron emission regions and a plurality of driving electrodes for controlling the electron emission of the electron emission regions, a light emission unit that is located on an inner surface of the second substrate, and a heat dissipation layer that defines an uppermost layer of the electron emission unit and has a thermal conductivity of at least 2 W/cmK, a portion of the heat dissipation layer extending out of the vacuum vessel through a region between the sealing member and the first substrate.

The heat dissipation layer may include a material selected from the group consisting of silver (Ag), copper (Cu), platinum (Pt), aluminum (Al), and combinations thereof. An insulation layer may be located between the driving electrodes and the heat dissipation layer. A portion of the insulation layer may extend out of the vacuum vessel through a region between the heat dissipation layer and the first substrate. The heat dissipation layer may be adapted to be applied with a voltage for focusing electron beams.

The heat dissipation layer may include a pair of longitudinal edges and a pair of lateral edges and at least one edge of the pair of longitudinal edges or the pair of lateral edges may be located outside the vacuum vessel. The at least one edge may include a plurality of heat dissipation projections.

The driving electrodes may include a plurality of cathode electrodes, a plurality of gate electrodes that are located above the cathode electrodes and cross the cathode electrodes, a first insulation layer being interposed between the cathode electrodes and the gate electrodes, and a focusing electrode that is located above the gate electrodes, a second insulation layer being interposed between the focusing electrode and the gate electrodes. The heat dissipation layer may be formed on the focusing electrode. The focusing electrode may include a material selected from the group consisting of chromium (Cr), molybdenum (Mo), and combinations thereof.

The light emission unit may include a phosphor layer for emitting white light and an anode electrode located on a surface of the phosphor layer. Alternatively, the light emission unit may include red, green, and blue phosphor layers spaced apart from each other, a black layer located between at least two of the red, green, and blue phosphor layers, and an anode electrode located on respective surfaces of the red, green, and blue phosphor layers and the black layer.

In another exemplary embodiment of the present invention, a light emission device includes a vacuum vessel that includes first and second substrates facing each other and a sealing member for sealing the first and second substrates, an electron emission unit that is located on an inner surface of the first substrate and includes a plurality of electron emission regions and a plurality of driving electrodes for controlling the electron emission of the electron emission regions, a light emission unit that is located on an inner surface of the second substrate, and a plurality of spacers that are located between the electron emission unit and the light emission unit. The driving electrodes include a first electrode that defines an uppermost layer of the electron emission unit and contacts the spacers, the first electrode having a thermal conductivity of at least 2 W/cmK, and a portion of the first electrode extending out of the vacuum vessel through a region between the sealing member and the first substrate.

The first electrode may include a material selected from the group consisting of silver (Ag), copper (Cu), platinum (Pt), aluminum (Al), and combinations thereof. The first electrode may include a pair of longitudinal edges and a pair of lateral edges, and at least one edge of the pair of longitudinal edges or the pair of lateral edges may be located outside the vacuum vessel. The at least one edge may include a plurality of heat dissipation projections.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a partial sectional view of a light emission device according to a first embodiment of the present invention.

FIG. 2 is a partially exploded perspective view of the light emission device of FIG. 1.

FIG. 3 is a partial sectional view of a light emission device according to a second embodiment of the present invention.

FIG. 4 is a top plan view of an electron emission unit and a first substrate of a light emission device according to a third embodiment of the present invention.

FIG. 5 is a top plan view of an electron emission unit and a first substrate of a light emission device according to a fourth embodiment of the present invention.

FIG. 6 is a partially cut-away perspective view of a light emission device according to a fifth embodiment of the present invention.

### DETAILED DESCRIPTION

In the following detailed description, only certain exemplary embodiments of the present invention are shown and described, by way of illustration. As those skilled in the art would recognize, the described exemplary embodiments may be modified in various ways, all without departing from the spirit or scope of the present invention. Accordingly, the drawings and description are to be regarded as illustrative in nature, and not restrictive.

In exemplary embodiments of the present invention, a light emission device can be referred to as a device for emitting light to an exterior thereof. In more detail, the light emission device may be used for transmitting information by displaying symbols, letters, numbers, and/or images. In addition, the light emission device may be used as a light source for emitting light to a passive-type display panel.

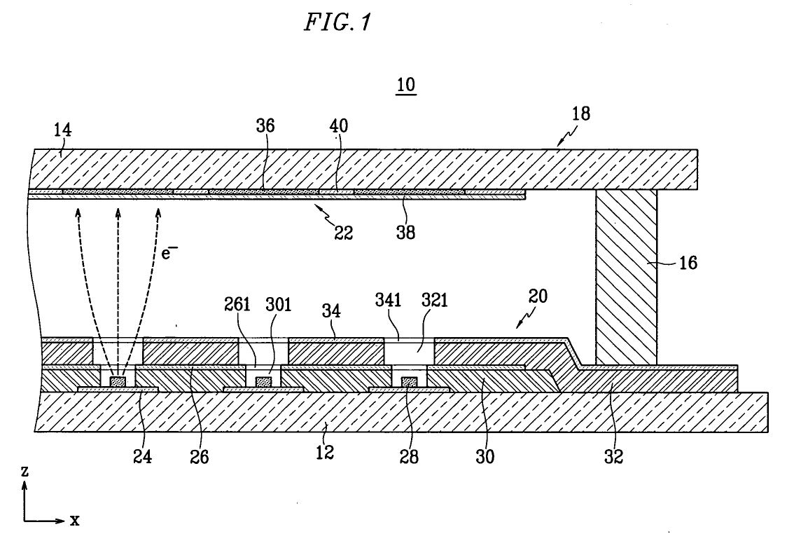

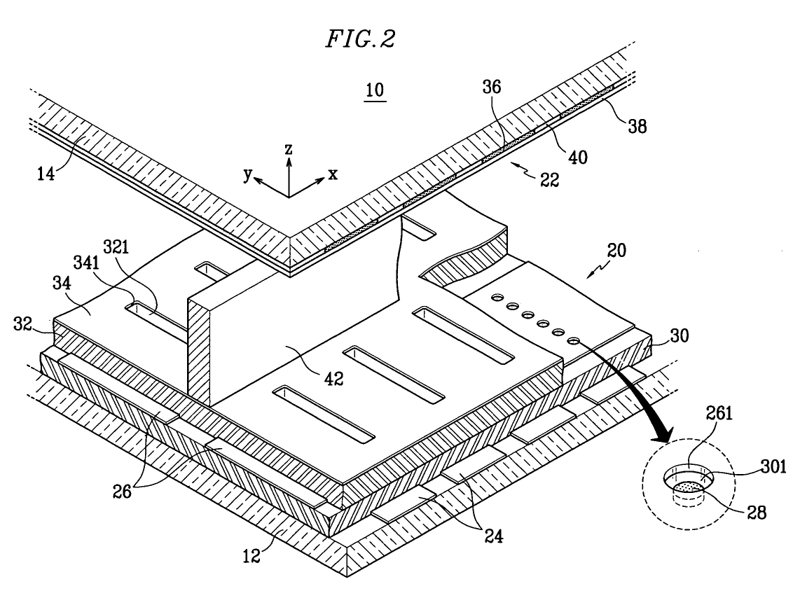

Referring to FIGS. 1 and 2, a light emission device 10 of a first embodiment of the present invention includes a first substrate 12 and a second substrate 14 facing the first substrate 12. The first substrate 12 and the second substrate 14 are spaced apart from each other by a certain (or predetermined) distance. A sealing member 16 is provided at peripheries (or peripheral regions) of the first substrate 12 and the second substrate 14 to seal them together, thereby forming a vacuum vessel 18. An interior of the vacuum vessel 18 is exhausted (or evacuated) such that a vacuum (or vacuum pressure) of about 10⁻⁶ Torr is maintained.

An electron emission unit 20 for emitting electrons toward the second substrate 14 is formed on an inner surface of the first substrate 12, and a light emission unit 22 is provided on an inner surface of the second substrate 14. The first substrate 12 may form a rear substrate of the light emission device 10, and the second substrate 14 may form a front substrate of the light emission device 10.

The electron emission unit 20 includes a plurality of cathode electrodes 24, a plurality of gate electrodes 26, and a plurality of electron emission regions 28 that are electrically connected to the cathode electrodes 24.

The cathode electrodes 24 are arranged in a stripe pattern extending along a first direction (e.g., a y-axis in FIG. 2) on the first substrate 12. A first insulation layer 30 is formed on an entire surface of the first substrate 12 to cover the cathode electrodes 24. The gate electrodes 26 are formed on the first insulation layer 30 and arranged in a stripe pattern extending along a second direction perpendicular to the first direction. That is, the gate electrodes 26 are disposed to cross the cathode electrodes 24.

Each crossing region of the cathode electrodes 24 and the gate electrodes 26 may correspond to a pixel region of the light emission device 10. Openings 261 and openings 301, which correspond to the respective pixel regions, are respectively formed in the gate electrodes 26 and the first insulation layer 30 to expose a surface of the cathode electrodes 24. The electron emission regions 28 are located on the cathode electrodes 24 at (or in) the openings 301 of the first insulation layer 30.

The electron emission regions 28 may be formed of a material, which emits electrons when an electric field is applied thereto in a vacuum atmosphere (or pressure). By way of example, the material may be a carbonaceous material and/or a nanometer-sized material. For example, the electron emission regions 28 may be formed of carbon nanotubes, graphite, graphite nanofibers, diamonds, diamond-like carbon, fullerene (e.g., C₆₀), silicon nanowires, or combinations thereof. The electron emission regions 28 may be formed by direct growth, a screen-printing process, chemical vapor deposition, and/or a sputtering process.

Alternatively, the electron emission regions 28 may be formed to have a tip-like structure. Here, the electron emission regions 28 may be formed of a Mo-based and/or a Si-based material. Alternatively, as shown in FIG. 2, circular-shaped electron emission regions 28 are arranged along a length of one (or more) of the cathodes electrode 24. However, embodiments of the present invention are not limited thereto. That is, the shape, number, and arrangement of the electron emission regions 28 may vary.

A second insulation layer 32 is formed on the first insulation layer 30 to cover the gate electrodes 26. A heat dissipation layer 34 is formed on the second insulation layer 32. The heat dissipation layer 34 defines an uppermost layer of the electron emission unit 20 and is adapted to dissipate heat generated from (or by) the electron emission unit 20 and direct the heat to an exterior of the light emission device 10. To achieve this, the heat dissipation layer 34 is formed of a material having a relatively high thermal conductivity of at least 2 W/cmK. As shown in FIG. 1, a portion of the heat dissipation layer 34 extends out of the vacuum vessel 18 at a region between the sealing member 16 and the first substrate 12 such that an end portion of the heat dissipation layer 34 is exposed to air outside of the vacuum vessel 18.

Openings 321 and openings 341, through which electron beams emitted from the electron emission regions 28 pass, are respectively formed in the second insulation layer 32 and the heat dissipation layer 34. The heat dissipation layer 34 may include a material selected from the group consisting of silver (Ag), copper (Cu), gold (Au), platinum (Pt), aluminum (Al), and combinations thereof.

The light emission unit 22 includes a phosphor layer 36 and an anode electrode 38. The phosphor layer 36 may be a phosphor mixed layer (e.g., a phosphor mixed layer having red, green and blue phosphors) for emitting white light. Here, the phosphor layer 36 may be formed on an entire active area of the second substrate 14 or formed to have a plurality of sections corresponding to the pixel regions. The light emission device 10 having the phosphor layer 36 may be used as a light source for emitting light to a passive-type display panel.

Alternatively, the phosphor layer 36 may include red, green, and blue phosphor layers corresponding to the respective pixel regions. Here, as shown in FIGS. 1 and 2, a black layer 40 for enhancing a contrast of an image may be formed between the red, green and blue phosphor layers of the phosphor layer 36. Here, the light emission device 10 can be used as a display for displaying one or more images.

The anode electrode 38 is formed on the phosphor layer 36. The anode electrode 38 may be a metal layer formed of aluminum (Al), for example. The anode electrode 38 places the phosphor layer 36 in a high potential state by receiving a voltage for accelerating electron beams and enhances a screen luminance by reflecting visible light radiated from the phosphor layer 36 to the first substrate 12 back toward the second substrate 14.

Alternatively, the anode electrode 38 may be a transparent conductive layer formed of, for example, indium tin oxide (ITO). Here, the anode electrode 38 is located between the second substrate 14 and the phosphor layer 36. Alternatively, the anode electrode 38 may include both a transparent conductive layer and a metal layer.

Disposed between the first substrate 12 and the second substrate 14 are spacers 42 (see, for example, FIG. 2) for countering a compression force applied to the vacuum vessel 18 and uniformly maintaining a gap between the first substrate 12 and the second substrate 14. In one embodiment, the spacers 42 are formed of a dielectric material such as glass and/or ceramic. Bottom surfaces of the spacers 42 contact the heat dissipation layer 34. In an embodiment in which the light emission unit 22 includes a black layer 40, the spacers 42 are located corresponding to a positioning of the black layer 40 such that the spacers 42 do not interfere with the light emission of the phosphor layer 36.

The above-described light emission device 10 is driven when driving voltages (which may be predetermined) are applied to the cathode electrodes 24, the gate electrodes 26, and the anode electrode 38. By way of example, one of the cathode electrodes 24 is applied with a scan driving voltage to serve as a scan driving electrode, and one of the gate electrodes 26 is applied with a data driving voltage to serve as a data driving electrode (or vice versa). The anode electrode 38 receives an anode voltage for accelerating the electron beams. The anode voltage may be a positive direct current (DC) voltage in a range from hundreds to thousands of volts.

Accordingly, electric fields are formed at (or around) the electron emission regions 28 at pixels (or pixel regions) where a voltage difference between the cathode electrodes 24 and the gate electrodes 26 is equal to or higher than a threshold value, and electrons are emitted from the electron emission regions 28. The emitted electrons collide with a corresponding portion of the phosphor layer 36 of the corresponding pixel by being attracted to the anode voltage applied to the anode electrode 38, thereby exciting the corresponding portion of the phosphor layer 36. A light emission intensity of (or at) a portion of the phosphor layer 36 corresponding to a pixel corresponds to an amount of electron beams emitted from the pixel.

When the light emission device 10 is driven for many hours, heat is generated from the cathode electrodes 24 and the gate electrodes 26, and thus the electron emission unit 20 may become over-heated. Here, since the heat dissipation layer 34 is formed at the uppermost layer of the electron emission unit 20, the heat generated from the electron emission unit 20 may be quickly dissipated (or directed away) through an end portion of the heat dissipation layer 34 exposed to air outside of the vacuum vessel 18.

Therefore, the light emission device 10 suppresses (or reduces) over-heating of the vacuum vessel 18 to increase (or enhance) a driving stability thereof. In addition, since a temperature of the first substrate 12 can be reduced by the heat dissipation layer 34, a temperature difference between the first substrate 12 and the second substrate 14 can also be reduced. As a result, a surface electric potential variation of the spacer 42 along a height of the spacer 42 can be suppressed (or reduced) and thus electron beam path distortion at (or around) the spacers 42 can be reduced (or minimized), thereby reducing an abnormal light emission at (or around) the spacers 42.

In addition, since the heat dissipation layer 34 may have a certain electric conductivity as well as a relatively high thermal conductivity, the heat dissipation layer 34 may serve as a focusing electrode. That is, the heat dissipation layer may receive a voltage (e.g., a DC voltage of 0V or a negative DC voltage in a range from several to tens of volts) for focusing an electron beam such that electrons are converged toward a central portion of a bundle of electron beams.

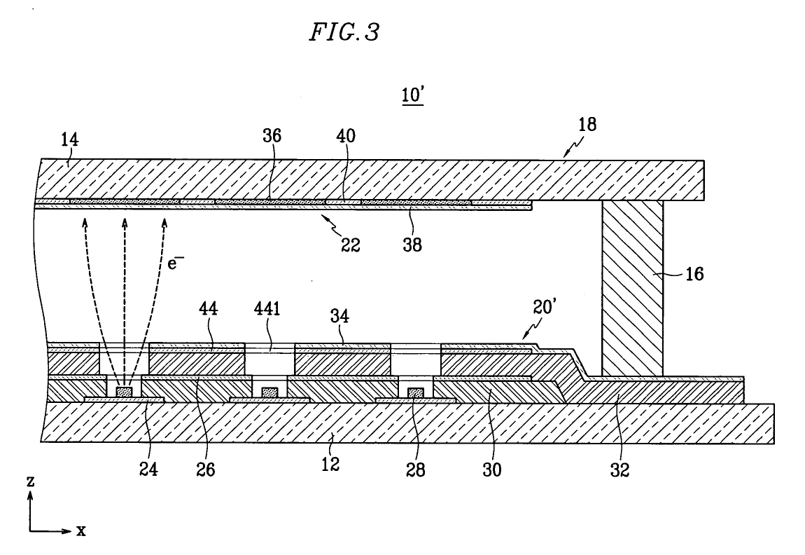

Referring to FIG. 3, a light emission device 10′ according to a second embodiment of the present invention includes a focusing electrode 44 located between the second insulation layer 32 and the heat dissipation layer 34.

Electron beam passing openings 441 are formed in the focusing electrode 44. The focusing electrode 44 receives a voltage for focusing electron beams. The focusing electrode 44 may include a material selected from the group consisting of molybdenum (Mo), chromium (Cr), and combinations thereof.

A top plan shape of the heat dissipation layer 34 will now be described in more detail with reference to FIGS. 4, 5, and 6.

Referring to FIG. 4, a light emission device according to a third embodiment of the present invention includes a cathode pad portion 46 located at a first peripheral portion of the first substrate 12 (e.g., an upper edge of the first substrate 12 in FIG. 4) and a gate pad portion 48 extending from the gate electrodes 26 and located at a second peripheral portion of the first substrate (e.g., a left edge of the first substrate 12 in FIG. 4).

A heat dissipation layer 34′ is located on an entire active area of the first substrate 12, The heat dissipation layer 34′ has a pair of longitudinal sides (or ends) extending along a first direction (e.g. the y-axis in FIG. 4) and a pair of lateral sides (or ends) extending along a second direction (e.g. the x-axis in FIG. 4). At least one of the lateral sides extends to a third peripheral portion of the first substrate 12 (e.g., a right edge of the first substrate 12 in FIG. 4) where the cathode pad portions 46 and the gate pad portions 48 are not located such that the lateral side can be exposed to air outside of the vacuum vessel 18.

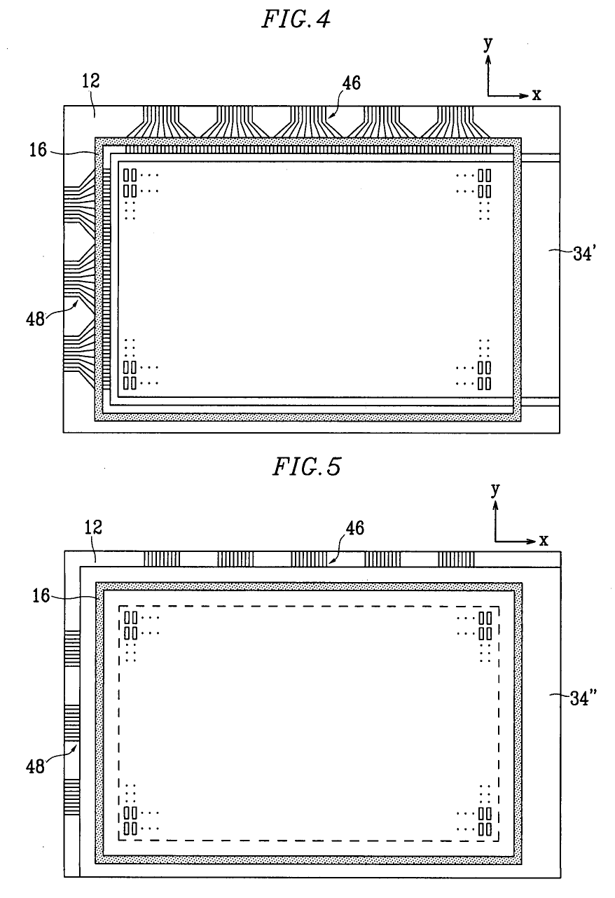

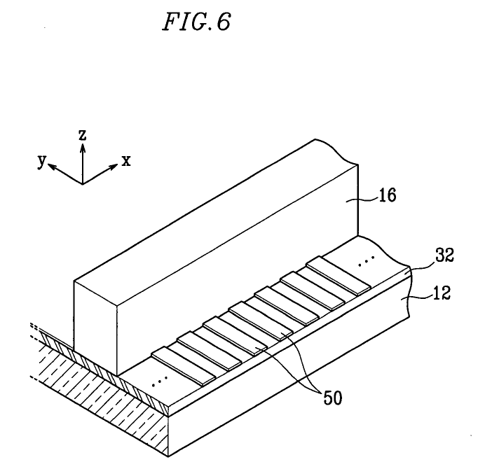

Referring to FIG. 5, a light emission device according to a fourth embodiment of the present invention is shown. A heat dissipation layer 34″ has a pair of longitudinal edges and a pair of lateral edges, all of which extend out of the vacuum vessel at a respective region between the sealing member 16 and the first substrate 12. Here, a portion of the second insulation layer (e.g., layer 32) is located under an exposed portion of the heat dissipation layer 34″ (see, for example, FIG. 3) to prevent a short circuit between the cathode pad portion 46 and the heat dissipation layer 34″. The larger the exposed portion of the heat dissipation layer 34″ is, the higher the heat dissipation effect will be.

Referring to FIG. 6, a light emission device according to a fifth embodiment of the present invention is shown. A plurality of heat dissipation projections 50 are formed along an exposed portion of the second insulation layer 32. However, embodiments of the present invention are not limited thereto. That is, the heat dissipation projection may have any of various suitable shapes.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A light emission device comprising:
a vacuum vessel including first and second substrates facing each other and a sealing member for sealing the first and second substrates;
an electron emission unit located on an inner surface of the first substrate and including a plurality of electron emission regions and a plurality of driving electrodes for controlling an electron emission of the electron emission regions;
a light emission unit located on an inner surface of the second substrate; and
a heat dissipation layer defining an uppermost layer of the electron emission unit and having a thermal conductivity of at least 2 W/cmK, a portion of the heat dissipation layer extending out of the vacuum vessel through a region between the sealing member and the first substrate.

2. The light emission device of claim 1, wherein the heat dissipation layer includes a material selected from the group consisting of silver (Ag), copper (Cu), platinum (Pt), aluminum (Al), and combinations thereof.

3. The light emission device of claim 1, further comprising an insulation layer located between the driving electrodes and the heat dissipation layer, wherein a portion of the insulation layer extends out of the vacuum vessel through a region between the heat dissipation layer and the first substrate.

4. The light emission device of claim 1, wherein the heat dissipation layer is adapted to be applied with a voltage for focusing electron beams.

5. The light emission device of claim 1,
wherein the heat dissipation layer includes a pair of longitudinal edges and a pair of lateral edges, and
wherein at least one edge of the pair of longitudinal edges or the pair of lateral edges is located outside the vacuum vessel.

6. The light emission device of claim 5, wherein the at least one edge comprises a plurality of heat dissipation projections.

7. The light emission device of claim 1, wherein the driving electrodes include:
a plurality of cathode electrodes;
a plurality of gate electrodes located above the cathode electrodes and crossing the cathode electrodes, a first insulation layer being interposed between the cathode electrodes and the gate electrodes; and
a focusing electrode located above the gate electrodes, a second insulation layer being interposed between the focusing electrode and the gate electrodes,
wherein the heat dissipation layer is formed on the focusing electrode.

8. The light emission device of claim 7,
wherein the focusing electrode includes a material selected from the group consisting of chromium (Cr), molybdenum (Mo), and combinations thereof, and
wherein the heat dissipation layer includes a material selected from the group consisting of silver (Ag), copper (Cu), platinum (Pt), aluminum (Al), and combinations thereof.

9. The light emission device of claim 7, wherein a portion of the second insulation layer extends out of the vacuum vessel at a region between the heat dissipation layer and the first substrate.

10. The light emission device of claim 1, wherein the light emission unit includes a phosphor layer for emitting white light and an anode electrode located on a surface of the phosphor layer.

11. The light emission device of claim 1, wherein the light emission unit includes red, green, and blue phosphor layers spaced apart from each other, a black layer located between at least two of the red, green, and blue phosphor layers, and an anode electrode located on respective surfaces of the red, green, and blue phosphor layers and the black layer.

12. The light emission device of claim 11, further comprising at least one spacer located between the light emission unit and the heat dissipation layer, the location of the at least one spacer corresponding to a positioning of the black layer.

13. The light emission device of claim 1, wherein the electron emission regions comprise a material selected from the group consisting of carbon nanotubes, graphite, graphite nanofibers, diamonds, diamond-like carbon, fullerene (C₆₀), silicon nanowires, and combinations thereof.

14. A light emission device comprising:
a vacuum vessel including first and second substrates facing each other and a sealing member for sealing the first and second substrates;
an electron emission unit located on an inner surface of the first substrate and including a plurality of electron emission regions and a plurality of driving electrodes for controlling an electron emission of the electron emission regions;
a light emission unit located on an inner surface of the second substrate; and
a plurality of spacers located between the electron emission unit and the light emission unit,
wherein the driving electrodes include a first electrode defining an uppermost layer of the electron emission unit and contacting the spacers, the first electrode having a thermal conductivity of at least 2 W/cmK, and a portion of the first electrode extending out of the vacuum vessel through a region between the sealing member and the first substrate.

15. The light emission device of claim 14, wherein the first electrode includes a material selected from the group consisting of silver (Ag), copper (Cu), platinum (Pt), aluminum (Al), and combinations thereof.

16. The light emission device of claim 14, wherein the first electrode includes a pair of longitudinal edges and a pair of lateral edges; and
at least one edge of the pair of longitudinal edges or the pair of lateral edges is located outside the vacuum vessel.

17. The light emission device of claim 16, wherein the at least one edge comprises a plurality of heat dissipation projections.

18. The light emission device of claim 14, wherein the first electrode is adapted to receive a voltage for focusing electron beams.

19. The light emission device of claim 14, wherein the driving electrodes further include:
a plurality of cathode electrodes;
a plurality of gate electrodes located above the cathode electrodes and crossing the cathode electrodes, a first insulation layer being interposed between the cathode electrodes and the gate electrodes; and
a second electrode located above the gate electrodes, a second insulation layer being interposed between the second electrode and the gate electrodes,
wherein the first electrode is formed on the second electrode.

20. The light emission device of claim 19,
wherein the second electrode includes a material selected from the group consisting of chromium (Cr), molybdenum (Mo), and combinations thereof, and
wherein the first electrode includes a material selected from the group consisting of silver (Ag), copper (Cu), platinum (Pt), aluminum (Al), and combinations thereof.
